(19) United States
(12) Patent Application Publication
(10) Pub. No.: US 2022/0236559 A1
(43) Pub. Date: Jul. 28, 2022

(54) Stereoscopic Head-Up Display with Symmetrical Optical Paths

(71) Applicant: E-LEAD ELECTRONIC CO., LTD., CHANGHUA (TW)

(72) Inventor: Stephen CHEN, CHANGHUA (TW)

(21) Appl. No.: 17/318,989

(22) Filed: May 12, 2021

(30) Foreign Application Priority Data
Jan. 22, 2021 (TW) 110102430

(51) Int. Cl. G02B 27/01; G02B 27/28; G02B 5/02; G02B 5/10; G02B 17/00

(52) U.S. Cl. CPC G02B 27/0101; G02B 27/283; G02B 5/0284; B60K 35/00; G02B 17/002; G02B 2027/0134; G02B 5/10

(57) ABSTRACT

A projection module, time-divisionally projecting a first image light and a second image light, a beam splitter, reflecting the first image light and allowing the second image light to pass through, a reflector module comprising two reflectors symmetrically at opposite ends of the beam splitter reflecting the first image light and the second image light individually, then projecting the first image light and the second image light to a reflective diffuser, the reflective diffuser projecting the first image light and the second image light to a receiving area of a first eye and a second eye. The optical paths are symmetrical between the beam splitter and the reflective diffuser, thereby maintaining the same optical paths length of the first eye and the second eye, the image on the reflective diffuser being clear, projecting a clear stereoscopic image in a longer virtual image distance or in a greater image magnification application.

### BACKGROUND

### Technical Field

The present disclosure is directed to a stereoscopic head-up display with symmetrical optical paths maintaining equal optical paths length of a left eye image and a right eye image in a longer virtual image projection distance or in a greater image magnification, the images on a reflective diffuser being clear, projecting a clear stereoscopic image on both eyes of an observer.

### Related Art

The optical path of an automotive head-up display is usually deployed with a concave mirror 61 to magnify an image on a screen as illustrated in FIG. 1A, especially configured on a Stereoscopic and Augmented-Reality HUD. In order to have the image fit more closely to reality and reduce vergence-accommodation conflict, a longer virtual image distance (VID), at least 7.5 meters to 20 meters, is required, hence a concave mirror 62 with a greater magnification required as illustrated in FIG. 1B.

Please refer to FIG. 2, cited references disclose a single projection module 1 provided with lens time-divisionally projecting a parallax image light of a left eye and a parallax image light of a right eye, a polarizing modulator 2 time-divisionally modulating the two image lights to a polarized parallax image light of the left eye and a polarized parallax image light of the right eye, the left eye parallax polarized image light and the right eye parallax polarized image light are orthogonal in polarizing direction, a beam splitter (a reflective polarizer 3) separates the two image lights by reflection and transmission. The reflected image light is projected to a reflective diffuser 5, the transmitted image light reflected by a reflector 40 behind the beam splitter (the reflective polarizer 3) and passing through the beam splitter (the reflective polarizer 3) once again, then projecting to the reflective diffuser 5. The reflective diffuser 5 reflecting and diffusing the polarized parallax image lights of both eyes to the concave mirror 6 to magnify the image displayed and lengthen the virtual image distance.

Please refer to FIG. 3, the polarized parallax image lights of both eyes are reflected individually to the left eye E1 and the right eye E2 of an observer by a windshield 7, each of both eyes seeing different parallax angles images, thereby forming a stereoscopic image in the brain of the observer.

Please refer to FIG. 4A, the beam splitter (the reflective polarizer 3) and the reflector 40 are configured for folding optical paths, accordingly its equivalent projection structure can be regarded as two projection modules 100 on both sides (left and right) respectively as shown in FIG. 4B, to perform a projection toward the reflective diffuser 5 with a included angle A between the center axles 101 of the two projection modules 100.

Please refer to FIG. 5A, the embodiment is suitable for a small projection angle difference, that is, the two equivalent projection modules on both sides (left and right) project to the reflective diffuser 5 with a smaller included angle between the center axle 101 of the two projection modules 100, for example, the included angle A1=5°. The projection modules project the image light to the reflective diffuser 5, the reflective diffuser 5 reflecting and diffusing the image light to the concave mirror 61, the concave mirror 61 reflecting the image light to the left eye E1 or the right eye E2 of the observer as shown in FIG. 5B. In some embodiments, a longer virtual image distance (VID) is required, the concave mirror 61 with a greater magnification is configured, that is, the radius of curvature is smaller. In this situation, the two equivalent projection modules on both sides (left and right) project to the reflective diffuser 5 at the same included angle, but the concave mirror 62 will not reflect the image light to the left eye E1 or the right eye E2 as shown in FIG. 5C.

Please refer to FIG. 6A, for a longer virtual image distance (VID) embodiments, the included angle of the two equivalent projection modules projecting to the reflective diffuser 5 shall be enlarged to let concave mirror 62 reflect and focus image light to the eyes of the observer, for example, the included angle A2=10°. As illustrated in FIG. 6B, the two projection modules on both sides (left and right) with larger included angle project the image light to the reflective diffuser 5, the reflective diffuser 5 reflecting and diffusing the image light to the concave mirror 62 with a greater magnification, the concave mirror 62 reflecting the image light to the left eye E1 or the right eye E2 of the observer.

Please refer to FIG. 7, the projection device, for example, a DLP or LCD projection device, comprises an image lens 10 provided with a focal distance, an image light L0 passing through the image lens 10, then projecting to a screen or a reflective diffuser 5 on the focal distance to form a clear image.

Please refer to FIG. 8A, cited references disclose the image lens 10 of the projection module projecting the image light separated by the beam splitter (the reflective polarizer 3) to form two different optical paths projecting to the reflective diffuser 5. The two optical paths are different in length, only one of the optical paths length being equal to the focal distance of the image lens 10. When the two equivalent projection modules of both sides (left and right) project to the reflective diffuser 5 at a small included angle, for example, the included angle is 5°, the optical path length difference is rather small. As illustrated in FIG. 8B, the optical path length of the polarized image light L11 is equal to the focal distance of the image lens 10, thus the polarized image light L11 forms a clear image on the reflective diffuser 5. As illustrated in FIG. 8C, the optical path length of the polarized image light L12 is slightly shorter than the focal distance of the image lens 10, thus the polarized image light L12 being focused not far behind the reflective diffuser 5, therefore the image being slightly vague. In some embodiments, the optical path length of the polarized image light L12 is equal to the focal distance of the image lens 10, thus the polarized image light L12 forms a clear image on the reflective diffuser 5, and the polarized image light L11 being focused not far behind the reflective diffuser 5, forming a slightly vague image.

Please refer to FIG. 9A, in some embodiments, a lager included angle is required to project to the reflective diffuser 5, for example, the included angle is larger than 10°, the optical path length passing through the beam splitter (the reflective polarizer 3) twice is obviously longer than the optical path length reflected by the beam splitter (the reflective polarizer 3), the two optical paths length difference is relatively greater. As illustrated in FIG. 9B, the optical path length of the polarized image light L11 is equal to the focal distance of the image lens 10, thus the polarized image light L11 forms a clear image on the reflective diffuser 5. As illustrated in FIG. 9C, the optical path length of the polarized image light L12 is shorter than the focal distance of the image lens 10, the polarized image light L12 being focused further behind the reflective diffuser 5, unable to form a clear image on the reflective diffuser 5, the image being rather blurred and difficult to be identified. In some embodiments, the optical path length of the polarized image light L12 is equal to the focal distance of the image lens 10, the polarized image light L12 forms a clear image on the reflective diffuser 5, the polarized image light L11 being focused further behind the reflective diffuser 5, unable to form a clear image on the reflective diffuser 5, the image being rather blurred and difficult to be identified.

Related technology could be referred to cited references JPH10186522A, TW578011, TW announcement number 396280, CN108919495, TW publication number 200916828, TW publication number 201019031, TW publication number 201214014, TW I349114, TW I359284, TW announcement number 342101, TW M478830, TW I626475, TW M434219 disclose an optical path of display for stereoscopic image.

### SUMMARY

The present disclosure is directed to a stereoscopic head-up display with symmetrical optical paths. The stereoscopic head-up display with symmetrical optical paths comprises the following.

A projection module has an image lens time-divisionally projecting a first image light and a second image light alternately.

A polarizing modulator modulates the first image light to a first polarized image light and modulates the second image light to a second polarized image light. The first polarized image light and the second polarized image light are orthogonal in polarizing direction.

A polarization beam splitter has a beam splitter surface reflecting the first polarized image light and allowing the second polarized image light to pass through.

A reflector module has two reflectors configured symmetrically at opposite ends of the beam splitter surface reflecting the first polarized image light and the second polarized image light individually.

A reflective diffuser has a plurality of micro-curved mirrors arranged in an array. Optical paths are symmetrical between the polarization beam splitter where the first polarized image light and the second polarized image light are separated and the reflective diffuser where the first polarized image light and the second polarized image light are projected to. The first polarized image light and the second polarized image light inject to the reflective diffuser at different angles. The plurality of the micro-curved mirrors reflect and diffuse the first polarized image light to a receiving area of a first eye. The plurality of the micro-curved mirrors reflect and diffuse the second polarized image light to a receiving area of a second eye.

The stereoscopic head-up display with symmetrical optical paths further comprises a windshield and a concave mirror. The concave mirror is configured between the reflective diffuser and the windshield. The reflective diffuser reflects and diffuses the first polarized image light and the second polarized image light to the concave mirror. The concave mirror reflects the first polarized image light and the second polarized image light to the windshield. The windshield reflects the first polarized image light and the second polarized image light individually to the receiving area of the first eye and the receiving area of the second eye.

The stereoscopic head-up display with symmetrical optical paths further comprises a shutter module provided with two shutters configured between the reflector module and the polarization beam splitter. Each shutter is individually placed between the symmetrical reflectors and the polarizing beam splitter. The shutters open and close at opposite timing which synchronizes with the projection module time-divisionally projecting the first image light and the second image light.

In some embodiments, the polarization beam splitter is a reflective polarizing film.

In some embodiments, the polarization beam splitter is a polarizing beam splitter cube.

In some embodiments, the stereoscopic head-up display with symmetrical optical paths comprises the following.

A projection module having an image lens time-divisionally projecting a first image light and a second image light.

A semi-reflective beam splitter is a semi-reflector provided with a semi-reflective surface partially reflecting a first image light and a second image light and allowing the first image light and the second image light to partially pass through.

A reflector module has two reflectors configured symmetrically at opposite ends of the semi-reflective surface reflecting the first image light and the second image light individually.

A shutter module has two shutters configured between the reflector module and the semi-reflector. Each shutter is individually placed between the symmetrical reflectors and the semi-reflective beam splitter. The shutters open and close at opposite timing which synchronizes with the projection module time-divisionally projecting the first image light and the second image light. When one of the image lights is projected, one of the shutters opens to project the image light to one of the reflectors. The other shutter closes to block and absorb the image light for preventing the image light from reaching the other reflector.

A reflective diffuser has a plurality of micro-curved mirrors arranged in an array. Optical paths are symmetrical between the semi-reflective beam splitter where the first image light and the second image light are separated and the reflective diffuser where the first image light and the second image light are projected to. The first image light and the second image light inject to the reflective diffuser at different angles. The plurality of the micro-curved mirrors reflect and diffuse the first image light to a receiving area of a first eye. The plurality of the micro-curved mirrors reflect and diffuse the second image light to a receiving area of a second eye.

In some embodiments, the stereoscopic head-up display with symmetrical optical paths further comprises a windshield and a concave mirror. The concave mirror is configured between the reflective diffuser and the windshield. The reflective diffuser reflects and diffuses the first image light and the second image light to the concave mirror. The concave mirror reflects the first image light and the second image light to the windshield. The windshield reflects the first image light and the second image light individually to the receiving area of the first eye and the receiving area of the second eye.

In some embodiments, the stereoscopic head-up display with symmetrical optical paths comprises the following.

A projection module has an image lens time-divisionally projecting a first image light and a second image light.

A reflective rotatable beam splitter is a rotatable shutter provided with a rotatable beam splitter surface defining a reflection area and a transmission area. The reflection area and the transmission area are alternative rotating to the projection path of the projection module, allowing the reflection area to reflect the first image light or allowing the second image light to pass through the transmission area.

A reflector module are two reflectors configured symmetrically at opposite ends of the rotatable beam splitter surface reflecting the first image light and the second image light individually.

A reflective diffuser has a plurality of micro-curved mirrors arranged in an array. Optical paths are symmetrical between the reflective rotatable beam splitter where the first image light and the second image light are separated and the reflective diffuser where the first image light and the second image light are projected to. The first image light and the second image light inject to the reflective diffuser at different angles. The plurality of the micro-curved mirrors reflect and diffuse the first image light to a receiving area of a first eye. The plurality of the micro-curved mirrors reflect and diffuse the second image light to a receiving area of a second eye.

In some embodiments, the stereoscopic head-up display with symmetrical optical paths further comprises a windshield and a concave mirror. The concave mirror is configured between the reflective diffuser and the windshield. The reflective diffuser reflects and diffuses the first image light and the second image light to the concave mirror. The concave mirror reflects the first image light and the second image light to the windshield. The windshield reflects the first image light and the second image light individually to the receiving area of the first eye and the receiving area of the second eye.

In some embodiments, the rotatable shutter is a disc shutter rotating around the center of the disc. The rotating speed of the disc synchronizes with the projection module time-divisionally projecting the first image light and the second image light. When the projection module projects the first image light, the disc rotates to the reflection area. The first image light is reflected by the reflection area. When the projection module projects the second image light, the disc rotates to the transmission area. The second image light passes through the transmission area.

### BRIEF DESCRIPTION OF THE DRAWINGS

FIG. 1A and FIG. 1B are schematic diagrams of a conventional automotive head-up display;

FIG. 2 is a schematic diagram of a conventional projection device projecting a stereoscopic image;

FIG. 3 is a schematic diagram of a conventional automotive head-up display projecting a stereoscopic image;

FIG. 4A and FIG. 4B are schematic diagrams of a conventional projection device projecting a stereoscopic image in equivalent optical path;

FIG. 5A, FIG. 5B and FIG. 5C are schematic diagrams of a conventional projection device projecting a stereoscopic image at different angles;

FIG. 6A and FIG. 6B are schematic diagrams of a conventional projection device projecting a stereoscopic image at different angles;

FIG. 7 is a schematic diagram of a conventional projection device showing an image lens focusing;

FIG. 8A, FIG. 8B and FIG. 8C are schematic diagrams of a conventional projection device projecting a stereoscopic image with small included angles; FIG. 8B is a schematic diagram illustrating the light (twice) passing through a beam splitter forming an optical path; FIG. 8C is a schematic diagram illustrating the light reflected by a beam splitter forming an optical path;

FIG. 9A, FIG. 9B and FIG. 9C are schematic diagrams of a conventional projection device projecting a stereoscopic image with large included angles; FIG. 9B is a schematic diagram illustrating the light (twice) passing through a beam splitter forming an optical path; FIG. 9C is a schematic diagram illustrating the light reflected by a beam splitter forming an optical path;

FIG. 10A, FIG. 10B and FIG. 10C are schematic diagrams illustrating a symmetrical optical paths of a stereoscopic image projection of the first embodiment of the instant disclosure;

FIG. 11A, FIG. 11B and FIG. 11C are schematic diagrams illustrating a symmetrical optical paths of a stereoscopic image projection with small projection included angles of the first embodiment of the instant disclosure;

FIG. 12A, FIG. 12B and FIG. 12C are schematic diagrams illustrating a symmetrical optical paths of a stereoscopic image projection with large projection included angles of the first embodiment of the instant disclosure;

FIG. 13A and FIG. 13B are three-dimensional schematic diagrams illustrating a symmetrical optical paths beam separation and projection of a stereoscopic image projection in an automobile of the first embodiment of the instant disclosure;

FIG. 14A and FIG. 14B are schematic diagrams illustrating a light leak of a symmetrical optical paths beam separation of a stereoscopic image projection of the first embodiment of the instant disclosure;

FIG. 15A, FIG. 15B and FIG. 15C are schematic diagrams illustrating a symmetrical optical paths beam separation and projection with shutters of a stereoscopic image projection of the first embodiment of the instant disclosure;

FIG. 16A and FIG. 16B are three-dimensional schematic diagrams illustrating a symmetrical optical paths beam separation and projection with shutters of a stereoscopic image projection of the first embodiment of the instant disclosure;

FIG. 17A and FIG. 17B are schematic diagrams illustrating a symmetrical optical paths beam separation and projection with shutters of a stereoscopic image projection of the second embodiment of the instant disclosure;

FIG. 18 is a three-dimensional schematic diagram illustrating a symmetrical optical paths beam separation and projection with shutters of a stereoscopic image projection of the second embodiment of the instant disclosure;

FIG. 19 is a three-dimensional schematic diagram illustrating a symmetrical optical paths beam separation and projection with shutters of a stereoscopic image projection in an automobile of the second embodiment of the instant disclosure;

FIG. 20A, FIG. 20B and FIG. 20C are schematic diagrams illustrating a symmetrical optical paths beam separation of a stereoscopic image projection of the third embodiment of the instant disclosure;

FIG. 21A and FIG. 21B are schematic diagrams illustrating a symmetrical optical paths beam separation and projection of a stereoscopic image projection of the third embodiment of the instant disclosure;

FIG. 22A and FIG. 22B are another schematic diagrams illustrating a symmetrical optical paths beam separation and projection of a stereoscopic image projection of the third embodiment of the instant disclosure;

FIG. 23 is a three-dimensional schematic diagram illustrating a symmetrical optical paths beam separation and projection of a stereoscopic image projection in an automobile of the third embodiment of the instant disclosure.

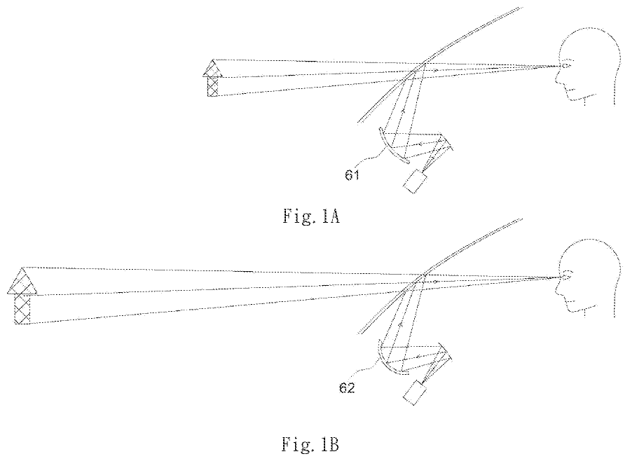

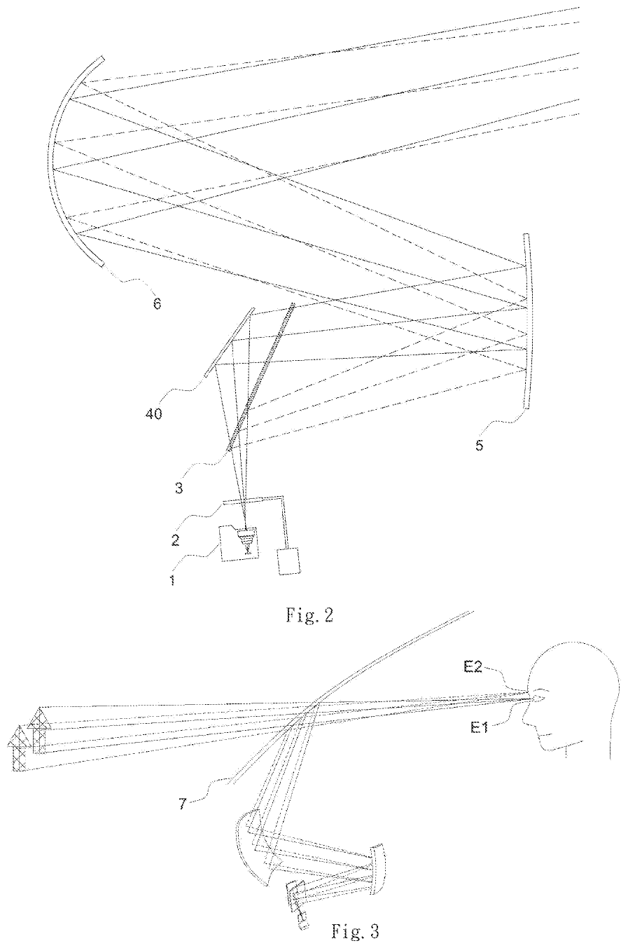

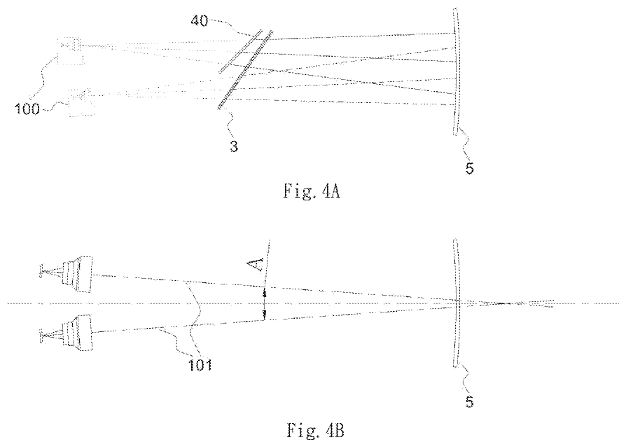

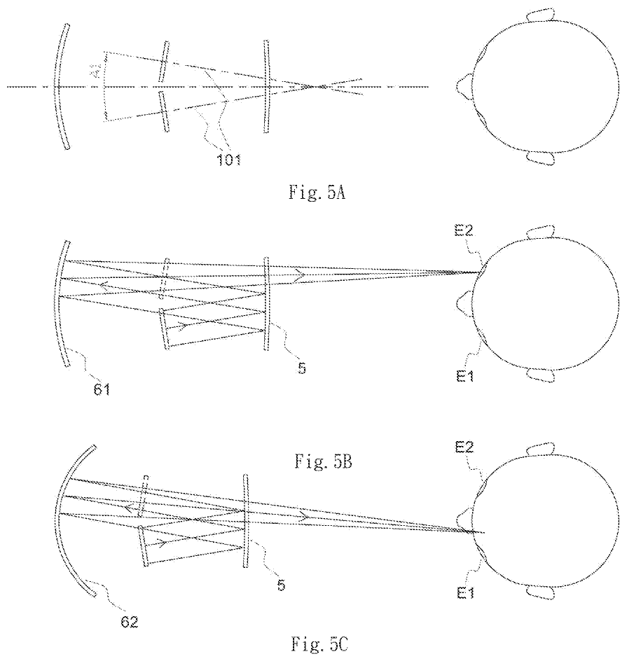

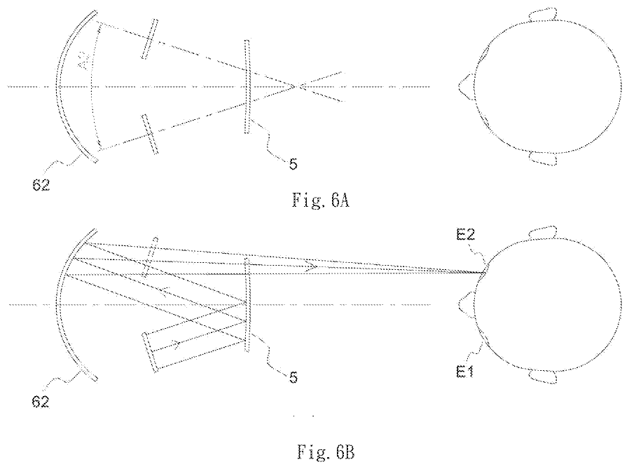

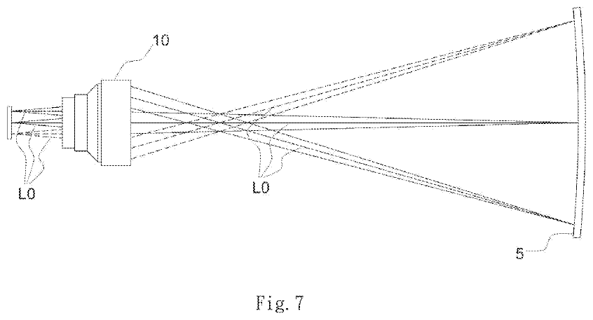

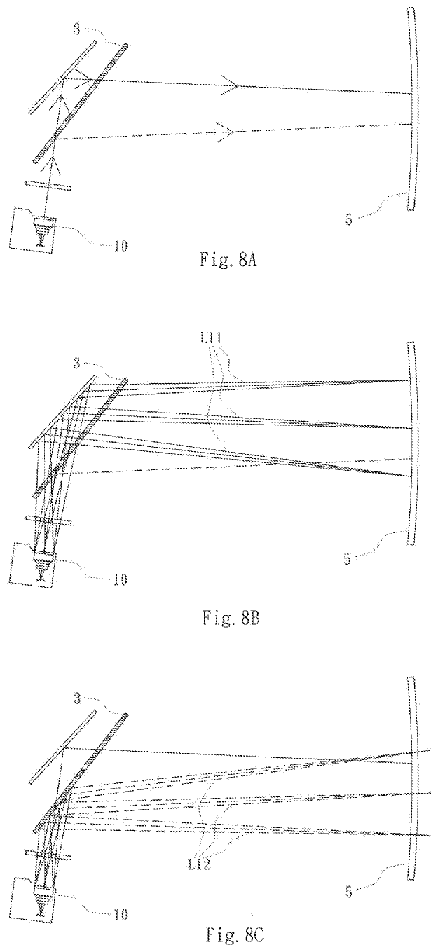

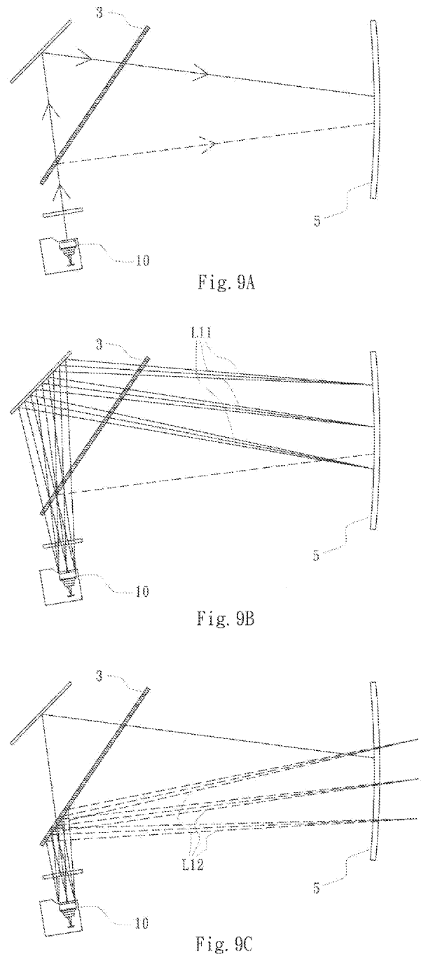

### DETAILED DESCRIPTION

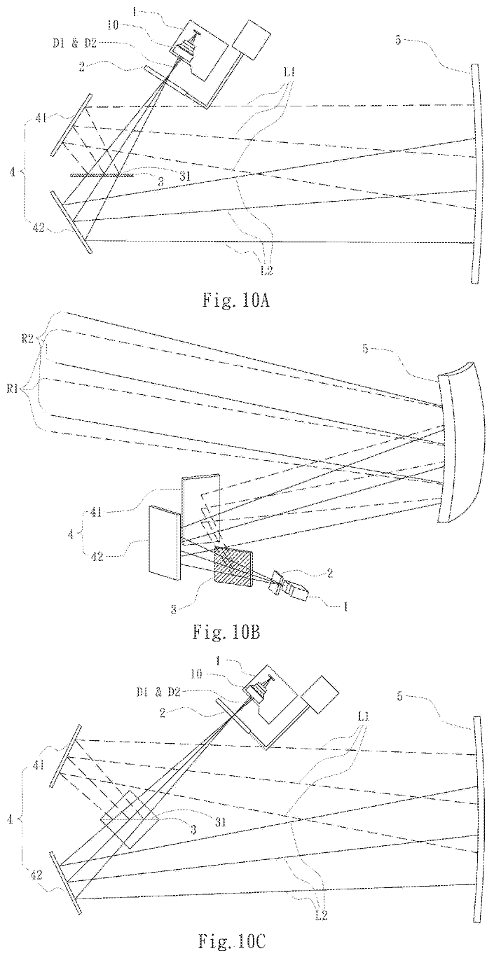

Please refer to FIG. 10A-FIG. 16B, the instant disclosure provides an embodiment of a stereoscopic head-up display with symmetrical optical paths comprising the following.

As illustrated in FIG. 10A, a projection module 1 has an image lens 10 time-divisionally projecting a first image light D1 and a second image light D2. The first image light D1 and the second image light D2 are provided with images at different parallax angles.

A polarizing modulator 2 modulates the first image light D1 to a first polarized image light L1 and modulates the second image light D2 to a second polarized image light L2. The first polarized image light L1 and the second polarized image light L2 are orthogonal in polarizing direction.

A polarization beam splitter 3 has a beam splitter surface 31 reflecting the first polarized image light L1 and allowing the second polarized image light L2 to pass through.

A reflector module 4 has two reflectors 41, 42 configured individually at opposite ends of the beam splitter 31 in a symmetrical manner. As illustrated in FIG. 10A, the reflectors 41, 42 are configured individually at an upper portion and a lower portion of the beam splitter 31. The reflector 41 reflects the first polarized image light L1 reflected by the polarization beam splitter 3. The reflector 42 reflects the second polarized image light L2 passed through the polarization beam splitter 3.

A reflective diffuser 5 has a plurality of micro-curved mirrors arranged in an array. Optical paths are symmetrical between the polarization beam splitter 3 where the first polarized image light L1 and the second polarized image light L2 are separated and the reflective diffuser 5 where the first polarized image light L1 and the second polarized image light L2 are projected to. The first polarized image light L1 and the second polarized image light L2 inject to the reflective diffuser 5 at different angles. As illustrated in FIG. 10B, the plurality of the micro-curved mirrors of the reflective diffuser 5 reflect and diffuse the first polarized image light L1 to a first area R1, the first area R1 extending to a receiving area of one eye. The plurality of the micro-curved mirrors of the reflective diffuser 5 reflect and diffuse the second polarized image light L2 to a second area R2, the second area R2 extending to a receiving area of the other eye. The polarization beam splitter is a reflective polarizing film (as shown in FIG. 10A) or a polarizing beam splitter cube (as shown in FIG. 10C).

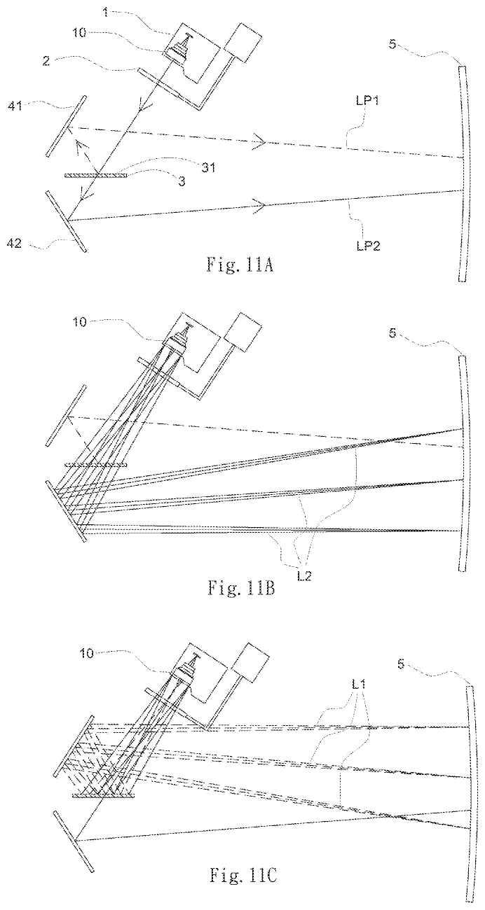

Please refer to FIG. 11A, the separated first polarized image light L1 and the separated second polarized image light L2 project individually to two different optical paths LP1, LP2 passing by the symmetrical arranged reflectors 41, 42 and reflected to the reflective diffuser 5. When the two optical paths LP1 and LP2 reach the reflective diffuser 5 at a smaller angle difference, for example, an included angle between LP1 and LP2 is 5°, the two optical paths LP1, LP2 being equal in length and symmetrical, the optical paths length from the two polarized image lights L1, L2 to the reflective diffuser 5 are equal to a focal distance of the image lens 10, thereby the two polarized image lights L1, L2 forming a clear image on the reflective diffuser 5 as shown in FIG. 11B and FIG. 11C.

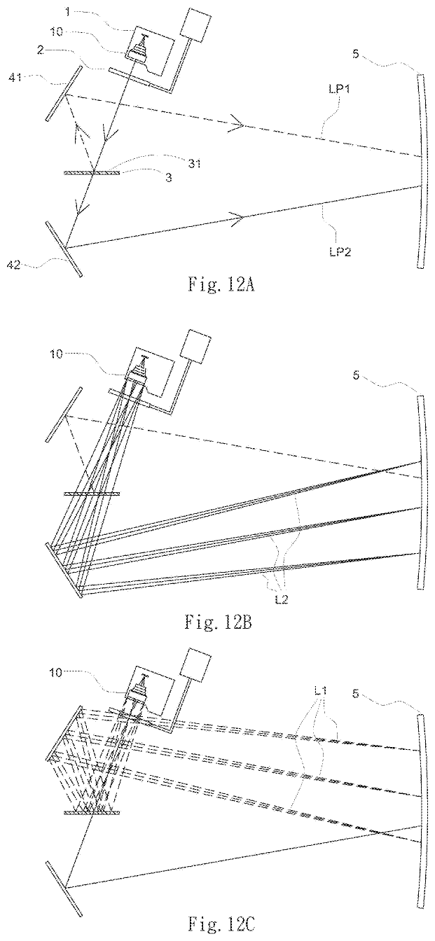

Please refer to FIG. 12A, when the two optical paths LP1 and LP2 reach the reflective diffuser 5 at a greater angle difference, for example, an included angle between LP1 and LP2 is greater than 10°, due to the symmetrical optical paths, no optical path length difference is occurred. The optical paths length from the two polarized image lights L1, L2 to the reflective diffuser 5 are equal to the focal distance of the image lens 10, thereby the two polarized image lights L1, L2 forming clear images on the reflective diffuser 5 as shown in FIG. 12B and FIG. 12C.

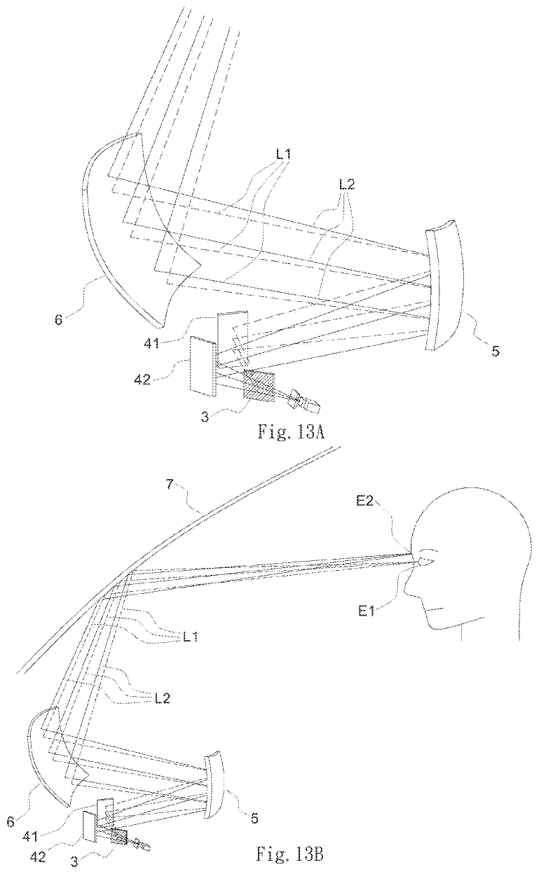

Please refer to FIG. 13A, the instant disclosure provides an embodiment of a stereoscopic head-up display with symmetrical optical paths comprising a windshield 7 and a concave mirror 6. The concave mirror 6 is configured between the reflective diffuser 5 and the windshield 7. The reflective diffuser 5 reflects and diffuses the first polarized image light L1 and the second polarized image light L2 to the concave mirror 6. The concave mirror 6 reflects the first polarized image light L1 and the second polarized image light L2 to the windshield 7. The windshield 7 reflects the first polarized image light L1 and the second polarized image light L2 individually to the receiving area of the first eye E1 and the receiving area of the second eye E2. The polarization beam splitter 3 is a reflective polarizing film or a polarizing beam splitter cube. The first polarized image light L1 and the second polarized image light L2 are separated by the polarization beam splitter 3, reflected to the reflective diffuser 5 by the symmetrical two reflectors 41, 42 individually. The reflective diffuser 5 reflects and diffuses the first polarized image light L1 and the second polarized image light L2 to the concave mirror 6, magnifying an image displayed and lengthening a virtual image distance. The concave mirror 6 reflects the first polarized image light L1 and the second polarized image light L2 to the windshield 7. The windshield 7 reflects the first polarized image light L1 and the second polarized image light L2 individually to the receiving area of the first eye E1 and the receiving area of the second eye E2 as shown in FIG. 13B, the left eye and the right eye individually seeing different parallax angles images, thereby forming a stereoscopic visual image in the brain of an observer.

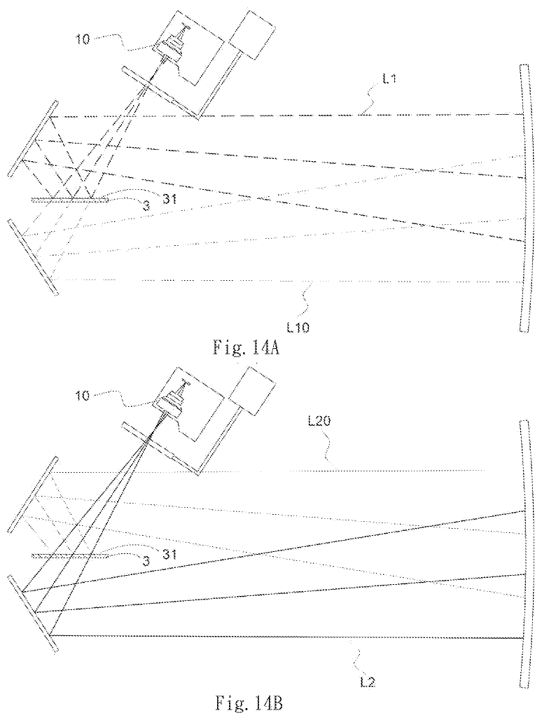

The first polarized image light L1 and the second polarized image light L2 are orthogonal in polarizing direction. One of the polarized image lights is reflected on the polarization beam splitter 3 while the other polarized image light passes through the polarization beam splitter 3 to separate the image lights beams. In an ideal embodiment, the first polarization beam splitter 3 reflects the entire first polarized image light L1 and allow the entire second polarized image light L2 to pass through. On a practical occasion, when the light passes through the interface of two different media, different proportions of reflections and transmission may occur. As shown in FIG. 14A, most of the first polarized image light L1 is reflected, partial of a transmitting light L10 entering the optical path of the second polarized image light L2. As shown in FIG. 14B, most of the second polarized image light L2 passes through, partial of a reflecting light L20 entering the optical path of the first polarized image light L1. Neither of the above separate the beam completely. Thus, the left eye sees slightly a right eye's image, for example 1/40 luminance of the right eye's image, the right eye seeing slightly a left eye's image, for example, 1/40 luminance of the left eye's image.

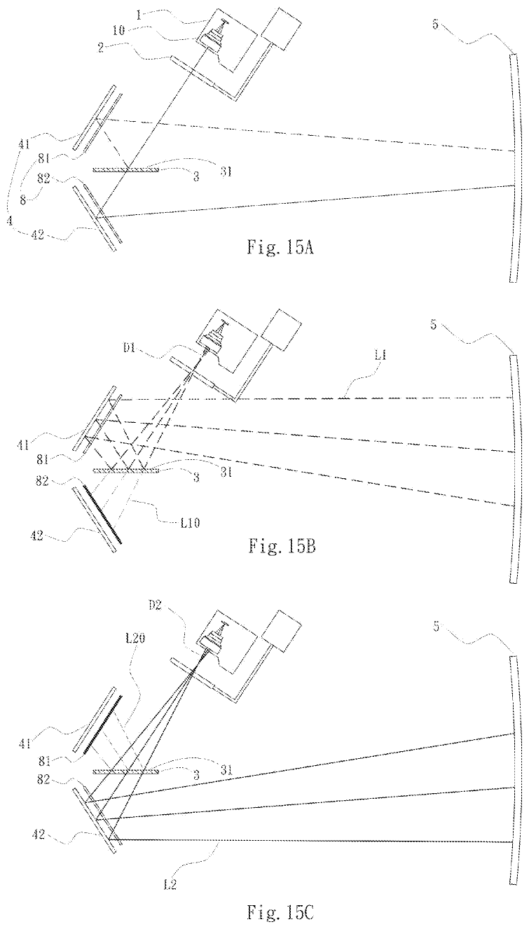

To overcome the light leak, as shown in FIG. 15A, the instant disclosure provides an embodiment of a stereoscopic head-up display with symmetrical optical paths comprising a shutter module 8 configured between the reflector module 4 and the polarization beam splitter 3. The symmetrical two reflectors 41, 42 are individually provided with shutters 81, 82 in the front thereof. The two shutters 81, 82 open and close at opposite timing. The timing synchronizes with the projection module 1 time-divisionally projecting the first image light D1 and the second image light D2 to overcome the problem of incomplete beam separation. On an occasion of partial light leak, the shutters 81, 82 are capable of blocking the leaked light to separate the beam completely. As shown in FIG. 15B, when the first image light D1 is projected, the shutter 81 opens, the first polarized image light L1 supposed to be reflected entirely on the polarization beam splitter 3, though the partial transmitting light L10 entering the optical path of the second polarized image light L2, the closing shutter 82 preventing the partial transmitting light L10 from reaching the reflector 42 by blocking and absorbing the partial transmitting light L10. As shown in FIG. 15C, when the second image light D2 is projected, the shutter 82 opens, the second polarized image light L2 supposed to be entirely passing through the polarization beam splitter 3, though the partial reflecting light L20 entering the optical path of the first polarized image light L1, the closing shutter 81 preventing the partial reflecting light L20 from reaching the reflector 41 by blocking and absorbing the partial reflecting light L20.

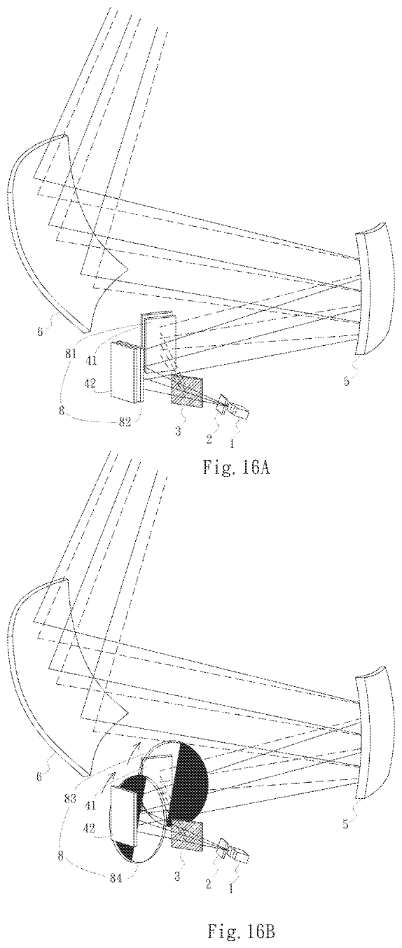

The shutter module 8 is an electronic shutter or a mechanical shutter. As shown in FIG. 16A, for example, the electronic shutter deploys electronic signals to control an opaque (closed) and a transparent (open) liquid crystal shutters 81, 82 of liquid crystal lens. As shown in FIG. 16B, for example, the mechanical shutter deploys a partial area of a disc for blocking (closing), the other area for passing through (opening), the rotatable shutters 83, 84 rotating around the center of the disc. The shutter module 8 working at opposite timing which synchronizing with the projection module are provided between the symmetrical reflectors 41, 42 and the polarization beam splitter 3. On an occasion that the polarization beam splitter 3 is unable to separate the beam completely, the leaked light being blocked, preventing the leaked light from entering the other optical path to achieve about 1/1000 effect, that is, one of the eyes sees only 1/1000 luminance of the other eye image, thereby substantially improving the stereoscopic visual quality.

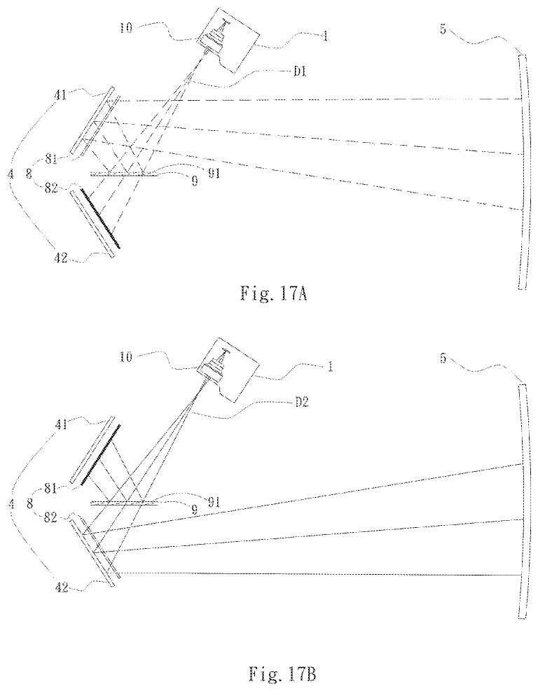

Please refer to FIG. 17A-FIG. 19, the instant disclosure provides an embodiment of a stereoscopic head-up display with symmetrical optical paths comprising the following.

A projection module 1 has an image lens 10 time-divisionally projecting a first image light D1 and a second image light D2.

A semi-reflective beam splitter is a semi-reflector 9 provided with a semi-reflector surface 91 partially reflecting the first image light D1 and the second image light D2, and allowing the first image light D1 and the second image light D2 to partially pass through.

A reflector module 4 has two reflectors 41, 42 configured symmetrically at opposite ends of the semi-reflective surface 91 reflecting the first image light D1 and the second image light D2 individually.

A shutter module 8 has two shutters 81, 82 configured between the reflector module 4 and the semi-reflector 9. The symmetrical reflectors 41, 42 are individually provided with shutters 81, 82 in the front thereof. When the first image light D1 is projected, the shutter 81 opens, enabling the partial reflected first image light D1 to inject to the reflector 41, then the partial reflected first image light D1 is projected by the reflector 41. The other shutter 82 closes, making the partial transmitted first image light D1 to be blocked and absorbed. When the second image light D2 is projected, the shutter 82 opens, enabling the partial transmitted second image light D2 to inject to the reflector 42, then the partial transmitted second image light D2 is projected by the reflector 42. The other shutter 81 closes, making the partial reflected second image light D2 to be blocked and absorbed.

A reflective diffuser 5 has a plurality of micro-curved mirrors arranged in an array. The optical paths are symmetrical between the semi-reflector 9 where the first image light D1 and the second image light D2 are separated and the reflective diffuser 5 where the first image light D1 and the second image light D2 are projected to. The first image light D1 and the second image light D2 inject to the reflective diffuser 5 at different angles. The plurality of the micro-curved mirrors reflect and diffuse the first image light D1 to a receiving area of one of the eyes. The plurality of the micro-curved mirrors reflect and diffuse the second image light D2 to a receiving area of the other eye.

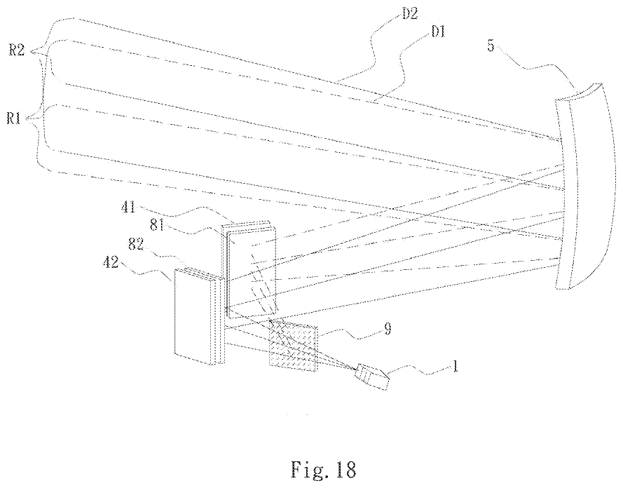

Please refer to FIG. 17A, FIG. 17B and FIG. 18, the shutter module 8 is capable of dealing with the light leak, in the first embodiment of the instant disclosure, a combination of the polarizing modulator 2 and polarization beam splitter 3 is replaced with the semi-reflective and semi-transmissive (e.g., 50% reflection/50% transmission) semi-reflector 9. The two shutters 81, 82 open and close at opposite timing. The timing synchronizes with the projection module 1 time-divisionally projecting the first image light D1 and the second image light D2 to achieve a similar effect of the first embodiment of the instant disclosure. Thus, the projection module 1 doesn't deploy with the polarizing modulator 2 in the front thereof, instead directly projecting the image light to the semi-reflector 9. When the projection module 1 projects the first image light D1, the first image light D1 reaches the two shutters 81, 82 simultaneously. The shutter 81 opens, enabling the first image light D1 reflected by the semi-reflector 9 to inject to the reflector 41, then the reflected first image light D1 is reflected to the reflective diffuser 5. The reflective diffuser 5 reflects and diffuses the first image light D1 to the first area R1, the first area R1 extending to a receiving area of one of the eyes. The other shutter 82 closes, the first image light D1 passing through the semi-reflector 9 being blocked and absorbed. When the projection module 1 projects the second image light D2, the second image light D2 reaches the two shutters 81, 82 simultaneously. The shutter 82 opens, the second image light D2 passing through the semi-reflector 9 to inject to the reflector 42, then the transmitting second image light D2 is reflected to the reflective diffuser 5. The reflective diffuser 5 reflects and diffuses the second image light D2 to the second area R2, the second area R2 extending to a receiving area of the other eye. The other shutter 81 closes, the second image light D2 reflected by the semi-reflector 9 being blocked and absorbed.

Although nearly half of the light is blocked and absorbed by the closing shutter module 8 making the light utilization rate lower to less than 50%, the polarizing modulator in the first embodiment of the instant disclosure has a similar phenomenon. The polarizing modulator 2 has a light transmittance lower than 50%. A combination of the semi-reflector 9 and the shutter module 8 with a symmetrical optical paths design, removing the polarizing modulator 2 and the polarization beam splitter 3 from the combination, thereby reducing the cost and achieving a light-leak-proof effect.

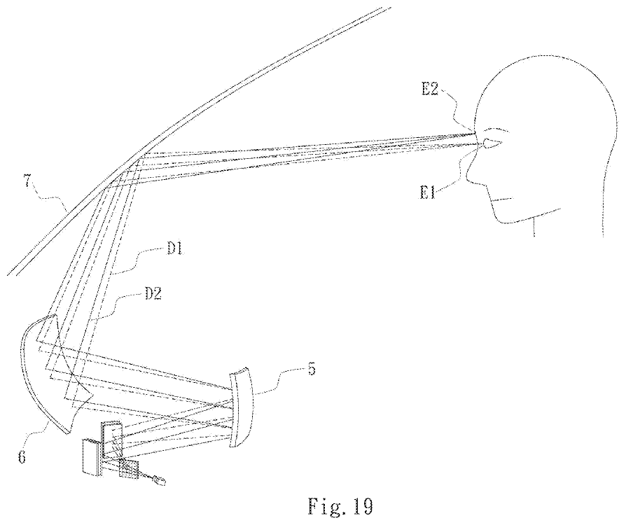

Please refer to FIG. 19, the instant disclosure provides an embodiment of a stereoscopic head-up display with symmetrical optical paths further comprising a windshield 7 and a concave mirror 6. The concave mirror 6 is configured between the reflective diffuser 5 and the windshield 7. The reflective diffuser 5 reflects and diffuses the first image light D1 and the second image light D2 to the concave mirror 6. The concave mirror 6 reflects the first image light D1 and the second image light D2 to the windshield 7. The windshield 7 reflects the first image light D1 and the second image light D2 individually to the receiving area of the first eye E1 and the receiving area of the second eye E2.

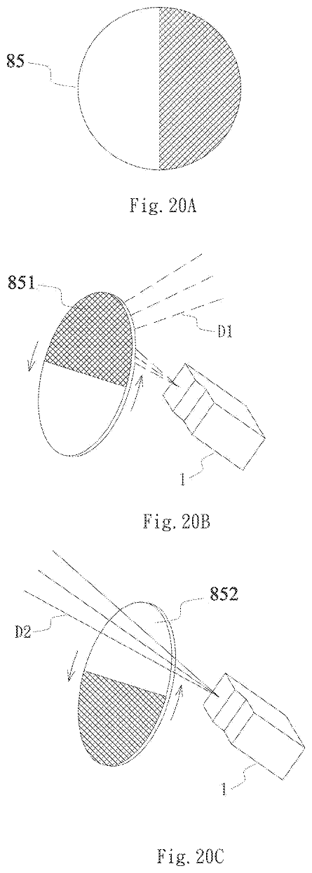

Please refer to FIG. 20-FIG. 23, the instant disclosure provides an embodiment of a stereoscopic head-up display with symmetrical optical paths comprising the following.

A projection module 1 has an image lens 10 time-divisionally projecting a first image light D1 and a second image light D2.

A reflective rotatable beam splitter is a rotatable shutter 85 provided with a rotatable beam splitter surface 850 centered on a shaft defining a reflection area 851 and a transmission area 852. The reflection area 851 and the transmission area 852 are alternative rotating to the projection path of the projection module 1, enabling the reflection area 851 to reflect the first image light D1 and allowing the second image light D2 to pass through the transmission area 852.

A reflector module 4 has two reflectors 41, 42 configured symmetrically at opposite ends of the rotatable beam splitter surface 850 reflecting the first image light D1 and the second image light D2 individually.

A reflective diffuser 5 has a plurality of micro-curved mirrors arranged in an array. The optical paths are symmetrical between the rotatable shutter 85 where the first image light D1 and the second image light D2 are separated and the reflective diffuser 5 where the first image light D1 and the second image light D1 are projected to. The first image light D1 and the second image light D2 inject to the reflective diffuser 5 at different angles. The plurality of the micro-curved mirrors reflects and diffuses the first image light D1 to a receiving area of a first eye E1. The plurality of the micro-curved mirrors reflect and diffuse the second image light D2 to a receiving area of a second eye E2.

Please refer to FIG. 20A, the rotatable shutter 85 is a disc shutter rotating around the center of the disc in clockwise or counterclockwise, the two radii from the center point of the disc defining one area as a reflection area 851 and the other area as a transmission area 852. In the embodiment of the instant disclosure, the diameter from the center point of the disc defines two areas as the reflection area 851 and the transmission area 852. The reflection area 851 is a reflective surface plated with silver or aluminum, or plated with coating to increase the light reflection. The transmission area 852 is made of a transparent material, such as glass, resin or crystal, or plated with coating to increase the light transmission. The rotatable shutter 85 is deployed to replace the combination of the polarizing modulator 2, the polarization beam splitter 3 and the two shutters 81, 82. The rotatable shutter 85 is configured at the position of the replaced polarization beam splitter 3. The rotating speed of the rotatable shutter 85 synchronizes with the projection module 1 time-divisionally projecting the first image light D1 and the second image light D2. As illustrated in FIG. 20B, when the projection module 1 projects the first image light D1, the rotatable shutter 85 rotates the reflection area 851 to the projection optical path of the projection module 1, the first image light D1 being reflected by the reflection area 851. As illustrated in FIG. 20C, when the projection module 1 projects the second image light D2, the rotatable shutter 85 rotates the transmission area 852 to the projection optical path of the projection module 1, the second image light D2 passing through the transmission area 852.

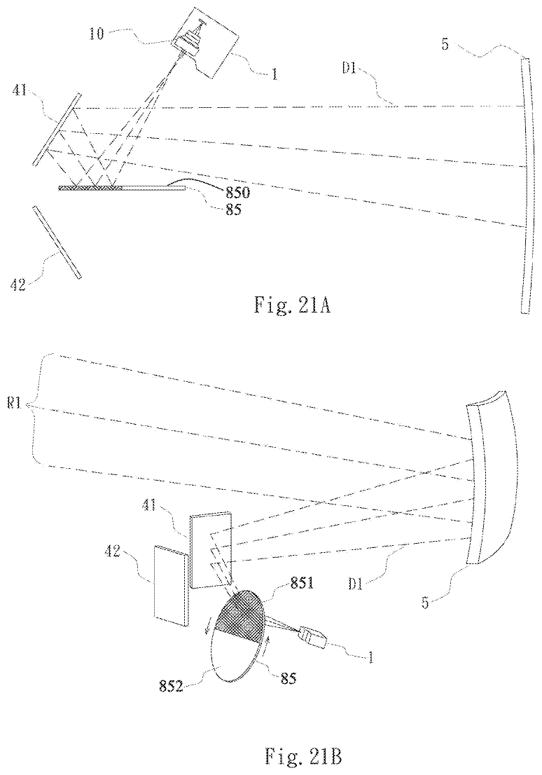

Please refer to FIG. 21A and FIG. 21B, when the projection module 1 projects the first image light D1, the rotatable shutter 85 rotates the reflection area 851 to the projection optical path of the projection module 1. The reflection area 851 reflects the first image light D1 to the reflector 41. The reflector 41 reflects the first image light D1 to the reflective diffuser 5. The reflective diffuser 5 reflects and diffuses the first image light D1 to the first area R1, the first area R1 extending to the receiving area of one of the eyes.

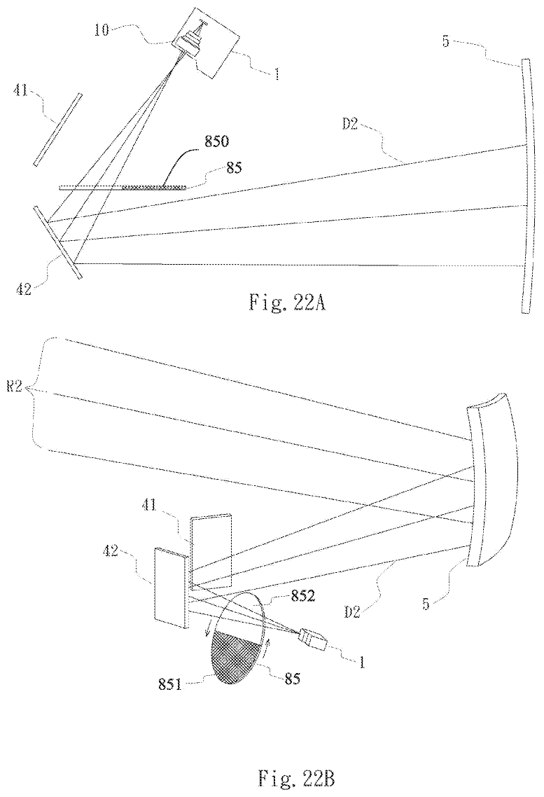

Please refer to FIG. 22A and FIG. 22B, when the projection module 1 projects the second image light D2, the rotatable shutter 85 rotates the transmission area 852 to the projection optical path of the projection module 1. The second image light D2 passes through the transmission area 852 to the reflector 42. The reflector 42 reflects the second image light D2 to the reflective diffuser 5. The reflective diffuser 5 reflects and diffuses the second image light D2 to the second area R2, the second area R2 extending to the receiving area of the other eye.

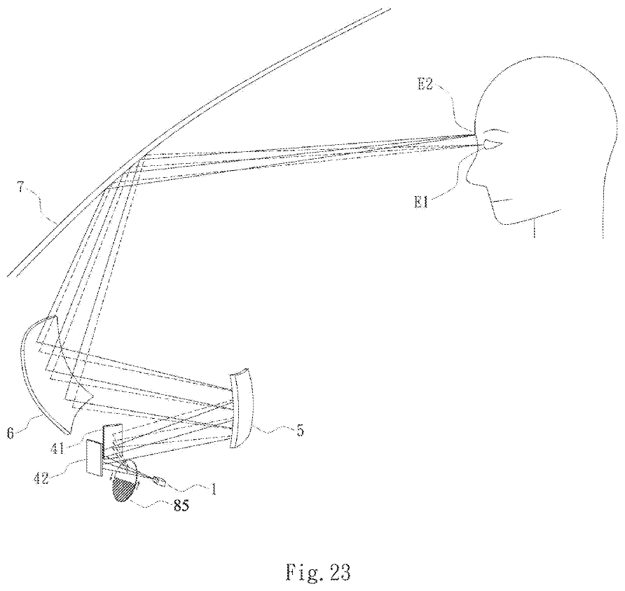

Please refer to FIG. 23, the instant disclosure provides an embodiment of a stereoscopic head-up display with symmetrical optical paths further comprising a windshield 7 and a concave mirror 6. The concave mirror 6 is configured between the reflective diffuser 5 and the windshield 7. The reflective diffuser 5 reflects and diffuses the first image light D1 and the second image light D2 to the concave mirror 6. The concave mirror 6 reflects the first image light D1 and the second image light D2 to the windshield 7. The windshield 7 reflects the first image light D1 and the second image light D2 individually to the receiving area of the first eye E1 and the receiving area of the second eye E2.

The above three embodiments of the instant disclosure deploy a single projection module along with a beam splitter and a symmetrical optical paths to achieve a clear stereoscopic visual effect. In the first embodiment, the image light is emitted by the image lens of the projection module, passing by the polarizing modulator time-divisionally modulate two image lights to two polarized image lights, the two polarized image lights being orthogonal in polarizing direction, the polarization beam splitter separate the two polarized image lights by reflecting and transmitting and become the polarized image light of the left eye and the polarized image light of the right eye, the symmetrical optical paths structure projecting the polarized image light of the left eye and the polarized image light of the right eye to the reflective diffuser at different angles, reflecting and diffusing individually to the receiving area of the left eye and the receiving area of the right eye to achieve a clear stereoscopic visual effect. The first embodiment is further deployed with two shutters to solve the light leak caused by the polarization beam splitter.

Since the two shutters can solve light leak problem, the second embodiment deploys a semi-reflective beam splitter to replace the combination of the polarizing modulator and the polarization beam splitter along with the symmetrical optical paths structure to achieve a clear stereoscopic visual effect.

The third embodiment deploys a reflective rotatable beam splitter to replace the combination of the polarization beam splitter and two shutters along with the symmetrical optical paths structure to achieve a clear stereoscopic visual effect.

It is worth mentioning in the above three embodiments the optical paths are symmetrical between the beam splitter (the polarization beam splitter 3, the semi-reflector 9, the rotatable shutter 85) where the image lights (the polarized image lights L1 and L2, the image light D1 and D2) are separated and the reflective diffuser 5 where the image lights reach after reflected by the reflectors 41, 42, thereby maintaining the image optical paths length of both eyes equal, the image on the reflective diffuser 5 being clear, projecting a clear stereoscopic visual effect in a longer virtual image projection distance or in a greater image magnification.

What is claimed is:

1. A stereoscopic head-up display with symmetrical optical paths, comprising:
a projection module, having an image lens time-divisionally projecting a first image light and a second image light;
a polarizing modulator, modulating the first image light to a first polarized image light and modulating the second image light to a second polarized image light; wherein the first polarized image light and the second polarized image light are orthogonal in polarizing direction;
a polarization beam splitter, having a beam splitter surface reflecting the first polarized image light and allowing the second polarized image light to pass through;
a reflector module, having two reflectors configured symmetrically at opposite ends of the beam splitter reflecting the first polarized image light and the second polarized image light individually;
a reflective diffuser, having a plurality of micro-curved mirrors arranged in an array;
wherein the first polarized image light and the second polarized image light inject to the reflective diffuser at different angles;
wherein the plurality of the micro-curved mirrors reflects and diffuses the first polarized image light to a receiving area of a first eye;
wherein the plurality of the micro-curved mirrors reflect and diffuse the second polarized image light to a receiving area of a second eye;
wherein the optical paths are symmetrical between the polarization beam splitter where the first polarized image light and the second polarized image light are separated and the reflective diffuser where the first polarized image light and the second polarized image light are projected to.

2. The stereoscopic head-up display with symmetrical optical paths of claim 1, further comprising a windshield and a concave mirror, wherein the concave mirror is configured between the reflective diffuser and the windshield, the reflective diffuser reflecting and diffusing the first polarized image light and the second polarized image light to the concave mirror, the concave mirror reflecting the first polarized image light and the second polarized image light to the windshield, the windshield reflecting the first polarized image light and the second polarized image light individually to the receiving area of the first eye and the receiving area of the second eye.

3. The stereoscopic head-up display with symmetrical optical paths of claim 1, further comprising a shutter module provided with two shutters configured between the reflector module and the polarization beam splitter, each shutter being individually placed between the symmetrical reflectors and the polarization beam splitter, the shutters opening and closing at opposite timing, the timing synchronizing with the projection module time-divisionally projecting the first image light and the second image light.

4. The stereoscopic head-up display with symmetrical optical paths of claim 1,
wherein the polarization beam splitter is a reflective polarizing film.

5. The stereoscopic head-up display with symmetrical optical paths of claim 1,
wherein the polarization beam splitter is a polarizing beam splitter cube.

6. A stereoscopic head-up display with symmetrical optical paths comprising:
a projection module, having an image lens time-divisionally projecting a first image light and a second image light;
a semi-reflective beam splitter, being a semi-reflector provided with a semi-reflective surface partially reflecting a first image light and a second image light and allowing the first image light and the second image light to partially pass through;
a reflector module, having two reflectors configured symmetrically at opposite ends of the semi-reflective surface reflecting the first image light and the second image light individually;
a shutter module, provided with two shutters configured between the reflector module and the semi-reflector, each shutter being individually placed between the symmetrical reflectors and the semi-reflector, the shutters opening and closing at opposite timing, the timing synchronizing with the projection module time-divisionally projecting the first image light and the second image light, wherein when one of the image lights is projected, one of the shutters opens, projecting the image light to one of the reflectors, wherein the other shutter closes, blocking the image light and prevent the image light from reaching the other reflector;
a reflective diffuser, having a plurality of micro-curved mirrors arranged in an array;
wherein the first image light and the second image light inject to the reflective diffuser at different angles;
wherein the plurality of the micro-curved mirrors reflect and diffuse the first image light to a receiving area of a first eye;
wherein the plurality of the micro-curved mirrors reflect and diffuse the second image light to a receiving area of a second eye;
wherein the optical paths are symmetrical between the semi-reflective beam splitter where the first image light and the second image light are separated and the reflective diffuser where the first image light and the second image light are projected to.

7. The stereoscopic head-up display with symmetrical optical paths of claim 6, further comprising a windshield and a concave mirror, wherein the concave mirror is configured between the reflective diffuser and the windshield, the reflective diffuser reflecting and diffusing the first image light and the second image light to the concave minor, the concave minor reflecting the first image light and the second image light to the windshield, the windshield reflecting the first image light and the second image light individually to the receiving area of the first eye and the receiving area of the second eye.

8. A stereoscopic head-up display with symmetrical optical paths comprising:
a projection module, having an image lens time-divisionally projecting a first image light and a second image light;
a reflective rotatable beam splitter, being a rotatable shutter provided with a rotatable beam splitter surface defining a reflection area and a transmission area;
wherein the reflection area and the transmission area are alternative rotating to the projection path of the projection module, enabling the reflection area to reflect the first image light or allowing the second image light to pass through the transmission area;
a reflector module, having two reflectors configured symmetrically at opposite ends of the rotatable beam splitter surface reflecting the first image light and the second image light individually;
a reflective diffuser, having a plurality of micro-curved mirrors arranged in an array;
wherein the first image light and the second image light inject to the reflective diffuser at different angles;
wherein the plurality of the micro-curved mirrors reflect and diffuse the first image light to a receiving area of a first eye;
wherein the plurality of the micro-curved mirrors reflect and diffuse the second image light to a receiving area of a second eye;
wherein the optical paths are symmetrical between the reflective rotatable beam splitter where the first image light and the second image light are separated and the reflective diffuser where the first image light and the second image light are projected to.

9. The stereoscopic head-up display with symmetrical optical paths of claim 8, further comprising a windshield and a concave mirror, wherein the concave mirror is configured between the reflective diffuser and the windshield, the reflective diffuser reflecting and diffusing the first image light and the second image light to the concave minor, the concave minor reflecting the first image light and the second image light to the windshield, the windshield reflecting the first image light and the second image light individually to the receiving area of the first eye and the receiving area of the second eye.

10. The stereoscopic head-up display with symmetrical optical paths of claim 8, wherein the rotatable shutter is a disc shutter rotating around the center of the disc making the reflection area and the transmission area alternately placed on a projection path of the projection module, the rotating speed of the disc synchronizing with the projection module time-divisionally projecting the first image light and the second image light.
